(19) United States
(12) Patent Application Publication
(10) Pub. No.: US 2017/0276760 A1
(43) Pub. Date: Sep. 28, 2017

(54) UPDATING POSITIONING DATA

(71) Applicant: SENSEWHERE LIMITED, Edinburgh (GB)

(72) Inventors: Firas ALSEHLY, Edinburgh (GB); Zankar Upendrakumar SEVAK, Edinburgh (GB); Tughrul Sati ARSLAN, Edinburgh (GB)

(21) Appl. No.: 15/503,818

(22) PCT Filed: Aug. 14, 2015
(86) PCT No.: PCT/GB2015/052358

§ 371 Date: Feb. 14, 2017

Related U.S. Application Data
(60) Provisional application No. 62/037,236, filed on Aug. 14, 2014.

(51) Int. Cl. G01S 5/02; H04W 4/02

(52) U.S. Cl. CPC G01S 5/0252; G01S 5/0236; H04W 4/02

(57) ABSTRACT

In a mobile positioning system, mobile user devices carry out data validation on locally stored positioning data, regulating the positioning data provided to a positioning module and selectively requesting updated positioning data from a central database. A controller receives requests for updated positioning data and selectively responds with updates. The mobile user devices store observations data concerning measurements of signals from electromagnetic signal sources and transmit data about the locally stored observations data to the controller. The controller then selectively requests transmission of the locally stored observations data and the mobile user device determines when and whether to transmit that data. The amount of positioning data which must be transmitted to and from the mobile user device and the overall power consumption of the mobile user device is reduced. The decision as to what observations data to transmit to the controller is distributed between the mobile user device and the controller.

### FIELD OF THE INVENTION

The invention relates to the field of apparatus and methods for estimating the position of a mobile user device, such as a mobile phone, personal digital assistant, laptop computer or tablet computer, by measuring signals from electromagnetic signal sources, such as wireless access points and other radio-frequency beacons. More particularly, the invention relates to maintaining and updating databases of positioning data for use in such systems.

### BACKGROUND TO THE INVENTION

It is known to provide a positioning system in which mobile user devices make an estimate of their position by measuring electromagnetic signals from electromagnetic signal sources, such as wireless access points and other radio-frequency beacons, and then using locally-stored data concerning the wireless access points to estimate their position. This positioning data is received from a centralised server database of positioning data across a wide geographic area. Data concerning the position of electromagnetic signals sources obtained from signal measurements made by individual mobile user devices are fed back to a controller, which uses this data to maintain and update the server database. This approach to maintaining the server database, using measurements from individual mobile user devices, has been referred to as crowd sourcing.

In order for such systems to work, positioning data must be transmitted from a server database to individual mobile user devices, so that they may make estimates of their position. Typically mobile user devices will receive positioning data concerning a region surrounding their current location, and it is known for mobile user devices to cache positioning data concerning geographical locations where they have recently been, or regularly go, to avoid receiving the same data over and over again. This can lead to them using out of date data.

Some aspects of the invention address the technical problem of reducing the amount of data which a mobile user device must receive from a server database in order to provide reliable positioning estimates using measurement of signals from electromagnetic signal sources. In particular, mobile user devices increase power consumption when they are receiving data over wireless communications channels, particularly when they receive the data using a cellular network communication system (such as 2G, 3G, 3.5G, 4G mobile communications network), and it is desirable to reduce this power consumption to maximise the time between battery recharges.

A potential strength of crowd sourced positioning systems is the possibility of receiving very large amounts of observation data (measurements of signals from electromagnetic signal sources, referred to herein as observations), made by many mobile user devices across a large geographic area. However, this presents technical challenges. Excessive amounts of observation data can require substantial resources to process. Furthermore, there are power consumption and bandwidth requirements associated with transmitting observation data from a mobile user device. Accordingly, some aspects of the invention address the technical problems arising from the requirement for mobile user devices to transmit observation data to a server in order to maintain the integrity of the server database.

### SUMMARY OF THE INVENTION

According to a first aspect of the present invention there is provided a method of maintaining stored positioning data on a mobile user device, comprising:
the mobile user device receiving and storing positioning data, the positioning data concerning a plurality of electromagnetic signals sources, (electromagnetic) signals from the said electromagnetic signal sources, and geographical locations of the said electromagnetic signal sources or (said electromagnetic) signals from the said electromagnetic signal sources;
subsequently carrying out a data validation procedure to determine whether to update the stored positioning data relating to a geographical region and, if so, requesting updated positioning data relevant to the said geographical region, receiving updated positioning data relevant to the said geographical region and updating the stored positioning data with the updated positioning data.

Accordingly, the mobile user device can regulate the amount of positioning data which it receives, with the aim of meeting (potentially varying) standards for the quality of position estimates, while minimising unnecessary data transfer and associated unnecessary bandwidth and power consumption requirements.

The positioning data may relate to the (typically estimated) geographical locations (e.g. 2D or 3D coordinates, for example latitude, longitude and optionally altitude) of electromagnetic signal sources (such as WAPs). A mobile user device can estimate its position using the geographical location of electromagnetic signals sources and measurements of signals (typically measurements of the strength of electromagnetic signals) from electromagnetic signal sources.

The positioning data may relate to the (expected) strength of signals from electromagnetic signal sources at geographical locations (e.g. 2D or 3D coordinates, for example latitude, longitude and optionally altitude). For example, the positioning data may comprise the (expected) strength of signals from a plurality of electromagnetic signal sources at each of a plurality of (2D or 3D) grid locations. This type of positioning data is typically referred to as fingerprint data. A mobile user device can estimate its position from fingerprint data by measuring the signals (typically measurements of the strength of electromagnetic signals) from electromagnetic signal sources, comparing these with the fingerprint data and estimating its positing as the geographical location of the most closely matching fingerprint data, or more typically using interpolation to compute a position intermediate the geographical location of stored fingerprint data. In a related strategy, the positioning data stores parameters of a function which describes the (expected) spatial variation in the strength of signals from a plurality of electromagnetic signal sources and the mobile user device processes this data to determine the location that best fits the measured strength of signals from electromagnetic signal sources. The positioning data may concern both the geographical locations of the said electromagnetic signal sources and the geographical location of signals from the said electromagnetic signal sources.

The data validation procedure typically analyses the stored positioning data relating to a geographical region to determine whether to update the stored positioning data relating to that geographical region. The positioning data may be grouped by or stored with reference to a plurality of discrete and typically predefined geographical regions, which may be of the same or different sizes and shapes. However the geographical region may simply be determined when required, for example to define the positioning data which is to be subject to the data validation procedure or to define the requested or received updated positioning data. Thus the method may comprise selecting or defining the said geographical regional. The request for updated positioning data may comprise a reference to the geographical region (for example an identifier of a geographical region, or a reference to a geographical location which is within a geographical region).

The geographical region which is subject to the validation procedure and/or the geographical region to which the requested updated positioning data and/or received updated positioning data relate, and the geographical region of the stored positioning data which is updated may be different, although relevant to the geographical region for which the data validation procedure relates. For example, it may be that the validation procedure is applied to a first geographical region which currently surrounds the mobile user device (e.g. a circle of defined radius, or rectangle of defined length and breadth), but a request is made for updated positioning data concerning a second geographical region (e.g. a grid square or other predefined area or volume) which is part of, overlaps with, or includes the first geographical region. This may, for example, occur because the validation procedure determines that only part of the first geographical region requires an update or because updates relate to predefined geographical regions and the first geographical region is not identical to any of the predefined geographical regions. The mobile user device may then receive updated positioning data concerning a third geographical region which is part of, overlaps with, includes or is adjacent to the second geographical region. This may occur because the controller which receives the request and responds with the updated positioning data will take into account it's knowledge of what updated positioning data is available and to what extent updated positioning data may assist the mobile user device. For example, the controller may be aware of substantial changes to positioning data concerning a geographical region which is proximate to the first or second geographical region and to transmit updated positioning data concerning that adjacent geographical region in addition to or instead of updated positioning data concerning the first or second geographical region.

The positioning data concerning a plurality of electromagnetic signal sources typically comprises identifiers of the plurality of electromagnetic signal sources (e.g. MAC addresses). It may comprise properties of the plurality of electromagnetic signal sources, such as the type of the electromagnetic signal sources.

It may be that the received updated positioning data comprises updates to the stored positioning data and the step of updating the positioning data does not replace all of the stored positioning data relating to the said geographical region.

By receiving updates and updating positioning data, the total amount of data received may be minimised, reducing power consumption.

The step of updating the stored positioning data may for example comprise one or more of: storing positioning data concerning one or more electromagnetic signal sources about which data was not previously stored, amending positioning data concerning one or more electromagnetic signal sources (for example, amending the estimated location of one or more electromagnetic signal sources), or removing data concerning one or more electromagnetic signal sources from the stored positioning data.

It may be that the data validation procedure takes into account a time associated with the stored positioning data.

The time associated with the positioning data may for example be one or more of: the time at which the positioning data was received by the mobile user device, the time at which the positioning data was transmitted by a remote server, the time at which the positioning data was updated by the mobile user device, or the time at which the positioning data was updated by a remote server. The time associated with the stored positioning data may be a time associated with the stored positioning data concerning the said geographical region, or part thereof.

It may be that the data validation procedure takes into account a parameter associated with the maturity, level of confidence, consistency, or expected rate of change of the stored positioning data relating to the geographical region, of part thereof.

The parameter may have a numerical value, with a higher or lower value being associated with greater maturity, level of confidence or expected rate of change of the positioning data. However, the parameter may for example be a flag or label, or any other datum. The parameter may be received with the positioning data, or updates to the positioning data. The parameter may be computed by the mobile user device.

Positioning data may be considered to be more mature if it has been generated from more measurements and/or from measurements of signals from more electromagnetic signal sources and/or if the improvement to the accuracy of the data which arises from receiving additional relevant observation data is lower. The expected rate of change of the positioning data may be determined taking into account a previous rate of change of the positioning data, for example, the rate at which electromagnetic signal sources are discovered, or disappear, or move. The level of confidence of the positioning data is typically related to the level of confidence of the position of a mobile user device which can be determined using the positioning data.

The stored positioning data may be a database of positioning data (referred to herein as the local database). The local database is retrievably stored in one or more tangible data storage media (such as RAM) of the mobile user device. By a database we refer to data retrievably stored on a tangible data storage device in an organised format from which selected data can be retrieved, and no limitation is intended to any specific format of database (e.g. hierarchical, relational, object, XML, graph).

The mobile user device may comprise a plurality of separate or separable components which are in (typically direct) wired or wireless communication with each other (e.g. a mobile telephone, tablet or computer and a separate or separable wearable component). One or more of the separate or separable components may be wearable components, for example a watch, glasses, or contact lenses. The stored positioning data may be distributed between more than one said component, or replicated in part in more the one said component.

It may be that the mobile user device estimates its position using a selected subset of the stored positioning data and the data validation procedure comprises determining which positioning data relating to a geographical region is to be used (e.g. by the positioning module) in the estimation of the position of the mobile user device.

It may be that the data validation procedure determines in some circumstances that some or all of the stored positioning data relating to the geographical region should not be selected for use in the estimation of the position of the mobile user device and requesting updated positioning data relevant to the geographical region.

The selected subset of the stored positioning data may for example be data comprising a subset of the electromagnetic signal sources which the positioning data concerning the geographical region concerns.

Data may be selected depending, for example, on a parameter associated with the accuracy, quality, maturity, consistency, a time associated with the data, or the age of the data. Data may be not selected responsive to determining that it is inconsistent.

It may be that positioning data is selected or deselected responsive to measurements by the mobile user device of signals from electromagnetic signal sources which the positioning data concerns.

The request for updated positioning data is typically transmitted to a controller. The controller typically comprises a server database storing positioning data. The controller typically receives the request for updated positioning data and transmits the updated positioning data, derived from data in the server database of stored positioning data, to the mobile user device. The controller may determine whether to transmit update positioning data. The controller may determine when to transmit updated positioning data. The controller determine which updated positioning data to send, for example the controller may determine which geographical region and/or which electromagnetic signal sources the updated positioning data should relate to.

It may be that the mobile user device transmits property data concerning one or more properties of stored positioning data relevant to the geographical region, to a controller.

The controller may determine from one or more said properties whether to send the updated positioning data to the mobile user device. The controller may determine from one or more said properties when to send the updated positioning data to the mobile user device. The controller may determine from one or more said properties which positioning data (e.g. in respect of which electromagnetic signal sources) to include in the updated positioning data sent to the mobile user device. The said determination may comprise comparing one or more said properties with a threshold. The determination may comprise comparing one or more said properties with a corresponding property of corresponding positioning data stored in the server database. The determination may also comprise one or more said properties with a corresponding property, sent by the mobile user device, of corresponding positioning data stored in the mobile user device (in the mobile user device local database of positioning data).

The property data may be a metric related to the quality of the stored positioning data relevant to position, for example, it may comprise one or more of the accuracy, maturity, consistency, or the age of the positioning data relevant to the geographical region, or a time associated with the positioning data relevant to the geographical region.

The mobile user device may transmit importance data concerning the relative importance of receiving updated positioning data, to a controller. The said importance data may be used by the controller to prioritise the sending of updates to the mobile user device.

The mobile user device may transmit requirement data indicative of a specific requirement of the mobile user device for positioning data to the controller. Requirement data may or example indicate to the controller that relatively more data is required in order to facilitate especially accurate position measurements.

The invention extends in a second aspect to a mobile user device comprising:
a positioning module programmed to estimate the position of the mobile user device from measurements of signals associated with one or more electromagnetic signal sources, with reference to stored positioning data;
a data validation module programmed to determine whether the stored positioning data relating to a geographical region should be updated and, if so, to request updated positioning data relevant to the said geographical region;
an updating module programmed to receive (typically requested) updated positioning data and to update the stored positioning data with the updated positioning data.

The stored positioning data typically concerning a plurality of electromagnetic signal sources, signals from the said electromagnetic signal sources, and geographical locations of the said electromagnetic signal sources or signals from the said electromagnetic signal sources.

The data validation module may be programmed to determine a subset of the stored positioning data which is used by the positioning module and to in some circumstances cause the position module to use none or only some of the stored positioning data concerning a geographical region and to request updated positioning data concerning the said geographical region.

The invention also extends to a mobile user device having a radio receiver, at least one processor, a memory in electronic communication with the at least one processor, the memory storing computer program code instructions which, when executed on the at least one processor, cause the mobile user device to function by the method of the first aspect of the invention.

In a third aspect of the invention there is provided a system comprising a controller, a server database in electronic communication with the controller, the server database storing positioning data, and a plurality of mobile user devices according to the second aspect of the present invention, which are at at least some times in electronic communication with the controller, the controller programmed to receive the requests for updated positioning data from the plurality of mobile user devices and to cause said updated positioning data from the server database to be transmitted to the said mobile user devices responsive to the said requests.

The controller may be programmed to cause said updated positioning data from the server database to be transmitted to the said mobile user devices selectively in responsive to the said requests. For example, the controller may not always transmit updated positioning data to mobile user devices responsive to requests. The controller may calculate to what extent additional or newer positioning data which from the server database may assist the mobile user device and take this into account when determining whether or when to send updated positioning data to a respective mobile user device in response to a said request.

The system may comprise a plurality of said controllers and server databases, a controller and respective server database being associated with each of a plurality of different geographical zones, the server database associated with each geographical zones storing positioning data concerning the respective geographical zone, the mobile user devices transmitting said request for updated positioning data to the controller associated with the geographical zone where the mobile user device is located and receiving updated positioning data from the server database associated with the geographical zone where the mobile user device is located.

A said server database or a further server database may be a master database storing positioning data concerning each geographical zone with which a controller and server database are associated. The said controllers may transmit updated positioning data from the servers databases to the master database and/or receive updated positioning data from the master database. Nevertheless, the master database is not essential. The geographical locations with which a controller and server database are associated may or may not overlap.

The invention also extends to a system comprising a controller, the controller comprising a plurality of servers, each comprising at least one processor in electronic communication with memory, and a plurality of mobile user devices having a radio receiver, at least one processor and memory in electronic communication with the at least one processor of the mobile user device, the said memories storing program code which, when executed by the respective processors causes the controller and mobile user devices to function as the system of the third aspect of the invention, or according to the method of the first aspect of the invention.

According to a fourth aspect of the invention, there is provided a method of updating a server database of positioning data using signal measurements made by mobile user devices, the server database comprising data concerning a plurality of electromagnetic signal sources, the method comprising:
a mobile user device measuring signal data from a plurality of electromagnetic signal sources and locally storing observation data derived from the measured signal data,
the mobile user device transmitting data about the locally stored observation data to a controller,
the controller selectively transmitting requests to the mobile user device to transmit at least some of the locally stored observation data;
the mobile user device receiving said requests and subsequently transmitting some or all of the requested locally stored observation data;
updating the server database using the transmitted observation data.

Accordingly, the server database may be updated using observation data obtained by many mobile user devices across a wide geographical area, but in a regulated way, minimising unnecessary data transfer and associated unnecessary power consumption.

The locally stored observation data is typically stored with reference to the geographical location (e.g. 2D or 3D coordinates) where the corresponding signal measurement was made. There are some alternative options, for example the locally stored observation data may be stored with reference to the time when the corresponding signal measurement was made and the geographical location where the corresponding signal measurement was made could be computed later. The transmitted observation data typically comprises data concerning signal strength measurements and locations to which the signal strength measurements relate.

It may be that, in at least some circumstances, the mobile user device delays sending requested locally stored observation data to the controller until at least one data transmission criterion is met, even whilst it is possible for the mobile user device to send the data to the controller through a communications channel.

It may be that the at least one data transmission criterion is selected to reduce the power consumption of the mobile user device associated with the transmission of observation data to the controller.

The at least one data transmission criterion may relate to whether the mobile user device is able to send the data to the controller through a relatively low power communication channel (e.g. WiFi). The at least one data transmission criterion may relate to the power currently required to transmit data from the mobile user device through a mobile communications network. For example, the at least one data transmission criterion may relate to the current power requirement to transmit data to a cellular communication network receiver. This may for example vary depending on the distance between the mobile user device and a cellular communications network receiver (e.g. mast). The at least one data transmission criterion may relate to the charge status of a battery of the mobile user device. The at least one data transmission criterion may relate to whether the mobile user device is being charged by a (wired or wireless) power source.

It may be that the requests to the user device include priority data and the mobile user device takes into account the priority data when determining whether and/or when to send locally stored observation data to the controller.

Accordingly, the controller can prioritise receiving and the mobile user device can prioritise sending observation data which the controller determines is of relatively high importance for updating the database of positioning data. The decision at to what observation data to send from the mobile user device to the controller may therefore be distributed between the controller and the mobile user device.

Observation data of relatively high priority may comprise data concerning geographical locations with a relatively low density of electromagnetic signal sources, or relatively more inaccurate data. The request to the user device may comprise an instruction to store additional data, responsive to which the mobile user device may store additional observation data, for example for a period of time, or while it remains in a specific location, which it would not have otherwise stored locally. The mobile user device will typically later transmit the additional observation data to the controller.

The data about the locally stored observation data may comprise data concerning the accuracy of the observation data. The data about the locally stored observation data may comprise data concerning the time at which the observation data was obtained. The data about the locally stored observation data may comprise data indicating detection of an electromagnetic signal source of which the mobile user device was not aware (in which case it may include an identifier of the detected electromagnetic signal source). The data about the locally stored observation data may comprise data identifying detected electromagnetic signal sources. The data about the locally stored observation data may comprise data concerning whether and/or to what extent the observation data is inconsistent with (locally) stored positioning data (received from the server database) (and therefore potentially indicative of an error in the database or a change, such as an electromagnetic signal source having moved or changed signal strength).

It may be that the controller transmits further data about the observation data received from the mobile user device, or concerning positioning data stored in the server database, to a further controller, the further controller requests selected observation data, or positioning data from the server database, from the controller responsive to the further data about the observation data, and the controller transmits the selected observation data, or positioning data from the server database, to the further controller.

The further data about the observation data may correspond to the abovementioned data about the locally stored observation data.

It may be that the controller transmits a request to the mobile user device to transmit locally stored observation data relating to a specific geographical region responsive to a request from the further controller for data concerning the specific geographical region.

The controller may be distributed between a plurality of computing devices (e.g. servers). The server database may be distributed between a plurality of physical servers or groups of servers. The method may comprise filtering the data about the locally stored observation data which is transmitted by the mobile user device before it reaches the controller. The method may comprise filtering or processing the requests for observation data transmitted by the controller to the mobile user device. The method may comprise generating or receiving requests for observation data concerning a geographical region and selecting one or more mobile user devices to which to transmit the request for observation data.

The invention also extends to a mobile user device having a radio receiver, at least one processor, a memory in electronic communication with the at least one processor, the memory storing computer program code instructions which, when executed on the at least one processor, cause the mobile user device to function by the method of the fourth aspect of the invention.

According to a fifth aspect of the present invention there is provided a mobile user device comprising stored positioning data, a radio receiver which measures signals from electromagnetic signal sources, a positioning module which estimates the position of the mobile user device from the signals measured by the radio receiver, a data store which stores observations data concerning signals from electromagnetic signal sources measured by the radio receiver, an observations upload module which is programmed to transmit data concerning the (locally stored) observations data and which is programmed to transmit selected stored observations data responsive to a received instruction.

The mobile user device typically estimates the position of the mobile user device from the signals measured by the radio receiver using stored positioning data, the stored positioning data concerning a plurality of electromagnetic signal sources, signals from the said electromagnetic signal sources, and geographical locations of the said electromagnetic signal sources or signals from the said electromagnetic signal sources.

The invention extends in a sixth aspect to a system comprising a controller, a server database of positioning data in electronic communication with the controller, and a plurality of mobile user devices, the server database comprising data concerning a plurality of electromagnetic signal sources,
a mobile user devices programmed to measure signal data from a plurality of electromagnetic signal sources and comprising local data storage locally storing observation data derived from the measured signal data,
the mobile user devices programmed to transmit data about the locally stored observation data about the locally stored observation data to the controller,
the controller programmed to transmit requests to the mobile user devices to transmit at least some of the locally stored observation data;
the mobile user devices programmed to receive said requests and subsequently transmit some or all of the requested locally stored observation data;
the controller programmed to update the server database using the observation data received from the mobile user devices.

The system may comprise a plurality of said controllers and respective server databases, and further comprising a master controller and a master database in electronic communication with the master controller,
the controllers programmed to transmit to the master controller further data about the observation data received by the respective controllers, or positioning data within the respective server database,
the master controller programmed to process the received further data about the observation data and to transmit requests to the respective controllers for selected observation data or positioning data,
the respective controller programmed to receive said requests and to transmit the requested observation data or positioning data to the master controller responsive thereto,
the master controller programmed to update the master database using the observation data or positioning data thereby received.

The system may comprise a controller selection module programmed to select a controller for an individual mobile user device to communicate with in dependence on the measured position of the mobile user device.

The controller selection module may be part of one or more said controllers. The controller selection module may be part of the master controller. The controller selection module may be part of a mobile user device. The controller selection module may be distributed.

The invention also extends to a system comprising a controller, the controller comprising a plurality of servers, each comprising at least one processor in electronic communication with memory, and a plurality of mobile user devices having a radio receiver, at least one processor and memory in electronic communication with the at least one processor of the mobile user device, the said memories storing program code which, when executed by the respective processors causes the controller and mobile user devices to function as the system of the fifth aspect of the invention, or according to the method of the sixth aspect of the invention.

Optional features described above in respect of any one of the six aspects of the invention are optional features of any of the six aspects of the invention.

### DESCRIPTION OF THE DRAWINGS

An example embodiment of the present invention will now be illustrated with reference to the following Figures in which:

FIG. 1 is a schematic diagram of a system implementing the invention with mobile user devices in communication with a controller and in proximity to a plurality of Wireless Access Points (WAPs);

FIG. 2 is a schematic diagram of components of a mobile user device;

FIG. 3 is a schematic diagram of the structure of the positioning and observation data in the local positioning database;

FIG. 4 is a flow chart of the procedure carried out by the data validation module;

FIG. 5 is a flow chart of the procedure carried out by the observations upload module of the mobile user device and the controller;

FIG. 6 is a schematic diagram of an embodiment in which the mobile user device comprises two components;

FIG. 7 is a schematic diagram of a system including a further (central) server.

### DETAILED DESCRIPTION OF AN EXAMPLE EMBODIMENT

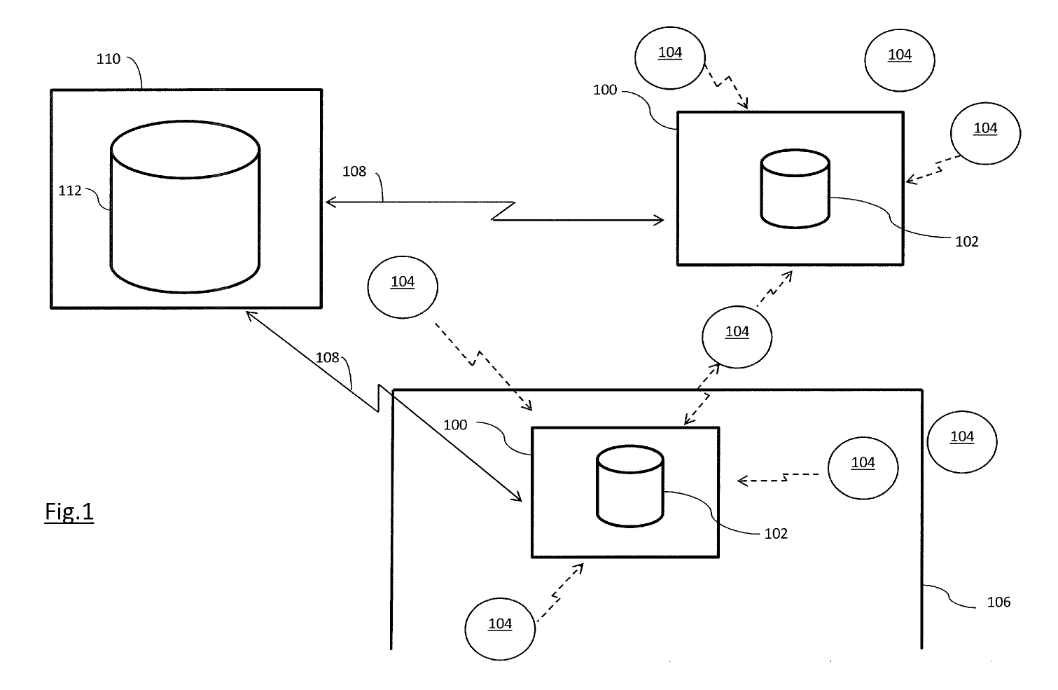

With reference to FIG. 1, a mobile positioning system comprises a plurality of mobile user devices (100), such as mobile telephones, laptops and tablets, each of which has locally stored positioning data (102), for use by the mobile user device in making an estimate of its position from measurements which it makes of signals from wireless access points (WAPs) (104), or other electromagnetic signal sources. The mobile user devices may well have additional positioning systems such as satellite navigation systems (e.g. GPS, Galileo, GLONASS, BeiDou), however mobile positioning systems which detect signals from wireless access points and other terrestrial electromagnetic signal sources are useful for accurate positioning, especially within buildings (106), where satellite signals may be unavailable, and have an advantage of relatively low power consumption compared to satellite navigation systems.

The mobile user devices are in at least occasional bi-directional communication with a positioning system controller (110), across a network (108). The network (108) is typically the internet and one skilled in the art will appreciate that mobile user devices can connect to the internet through various wired and wireless communications technologies. At least some of the mobile user devices will typically be able to communicate using at least two different wireless communications technologies which have different power consumptions, for example, that may have a transceiver for a cellular telephone network and a transceiver for a WiFi data network. The system controller (110) maintains a server database (112) of positioning data concerning electromagnetic signals sources covering a wide geographic area (e.g. a town, a country, continent or the world) and individual mobile uses devices store positioning data concerning a limited subset of the geographic area. The data positioning data comprises identifiers of stationary electromagnetic signal sources, an estimate of their position (e.g. latitude, longitude and optionally altitude or x, y and optionally z coordinates of a suitable reference frame), and parameters associated with their signal strength (e.g. a numerical value indicative of signal strength or a reference to the type of electromagnetic signal source, from which signal strength can be deduced), as well as other relevant data, such as a how long the electromagnetic signal source has remained at its current location, how frequently the electromagnetic signal source has been detected, a level of confidence that the electromagnetic signal source is a stationary electromagnetic signal source etc.

In FIG. 1, the controller and server database are shown as a single integrated unit for the purpose of clarity. However, one skilled in the art will appreciate that the functionality of the controller and the server database may be distributed (including replicated) across many different servers, in the same or different locations, or implemented using technology such as virtual servers. An individual mobile user device may transmit data to one server of the controller and receive data from another server of the controller.

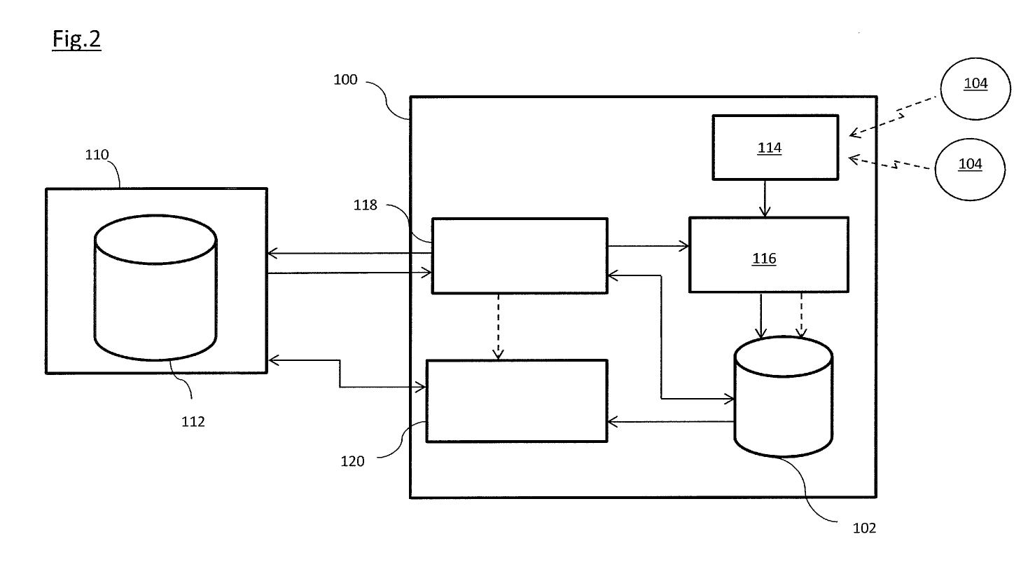

FIG. 2 is a schematic diagram of components of a mobile user device within the system, and the flow of data between these components. A radio receiver (114) receives signals from WAPs and measures the strength of signals received from WAPs. A positioning module (116) is programmed to estimate the position of the mobile user device using measurements from the radio receiver, and reference data concerning this electromagnetic signal strength. Local database (102) stores positioning data, which is discussed further below. Validation module (118) is programmed to carry out a data validation procedure on positioning data in the local database (102) and, depending on the quality of the data, to pass data concerning selected WAPs to the positioning module or to request additional positioning data from the controller where required. An observations upload module (120) is programmed to selectively transmit observations to the controller, for use in updating the server database.

These individual modules and their function will now be discussed individually. The radio receiver (114) has an antenna and associated radio frequency electronic circuits and may for example be a WiFi transceiver module. The positioning module (116), validation module (118) and observations upload module (120) can be implemented in software or hardware, or a mixture thereof. In an example embodiment, the positioning module is implemented by a specialised semiconductor and the validation module and observations upload module are implemented by computer program code stored in memory (which may be the same or different memory to that used to store the local database (102)) and executed by a microprocessor of the mobile user device in electronic communication with the memory. The positioning module (116) calculates estimates of the position of the mobile user device from the strength of signals received by the radio receiver (114), for example, by calculating the distance of the mobile user device from each of the electromagnetic signal sources using the following formula:

$${P}_{r} = \frac{{P}_{t} {G}_{t} {G}_{r} {λ}^{2}}{{( 4 π )}^{2} {d}^{2}} \qquad ( 1 )$$

where Pᵣ is the received signal power at the user device, Pₜ is the transmitted power of the electromagnetic signal source, Gᵣ and Gₜ are the receiver and transmitter gains respectively, λ is the signal wavelength and d is a distance between source and receiver.

This function may alternatively be expressed in terms of propagation gain (PG) as:

$$PG = \frac{{P}_{r}}{{P}_{t} {G}_{t} {G}_{r}} = \frac{{λ}^{2}}{{( 4 π )}^{2} {d}^{2}} \qquad ( 2 )$$

and in decibels form as:

PG_{dB}=20 log(λ/4πd) (3)

Typically, all of the parameters of the above equations, apart from distance, d, are known to the mobile user device either from the data measured from the electromagnetic signal sources or from the locally stored positioning data received from the controller. Accordingly, the mobile user device may determine its distance, d, from a given electromagnetic signal source using the above equation.

The above equation is useful for a free space environment, but may not be sufficiently accurate for use in “real world” indoor environments such as tunnels or shopping centres. An alternative equation for use in such indoor environments may be:

PG_{dB}=20 log(λ/4πd₀)+10n log(d/d₀)+X_{σ} (4)

where X, n and d₀ are parameters which vary with different indoor environments and which can be determined empirically.

By processing the known positions of electromagnetic signal sources together with the distances calculated from each electromagnetic signal source, the position of the mobile user device can be estimated by, for example, triangulation.

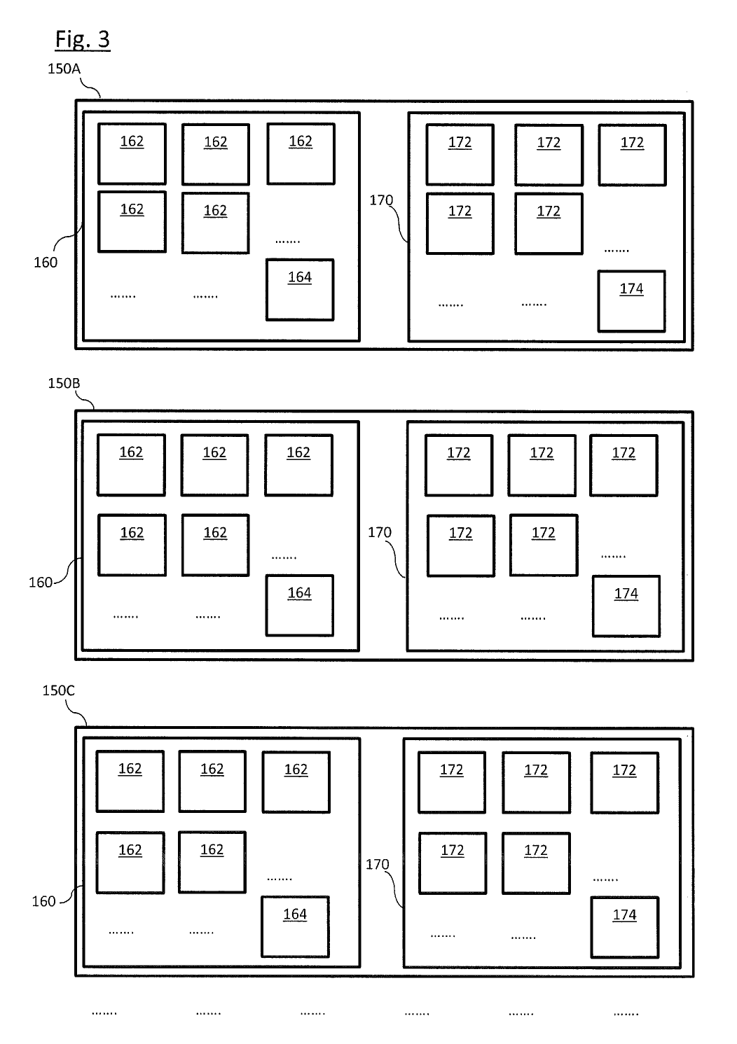

FIG. 3 illustrates the structure of locally stored positioning data. The data is stored as data structures relating to different geographical regions (150A, 150B, 150C). In a simple embodiment, these different locations may be squares of a certain size, (for example 100 m, 250 m or 1 km width and depth, or 0.01 degrees of latitude and longitude). However, there is no requirement for these regions to be the same size and shape as each other. Smaller regions may be defined where there is a high density of WAPs, and larger regions may be defined where there is a low density of WAPs. Regions may be ascribed to specific structures, or parts thereof, such as a building, a floor of a building, an airport terminal, a shopping centre, a sports stadium.

For each region, the local database stores positioning data comprising electromagnetic signal source data (160) and observations data (170). The electromagnetic signal source data (160) comprises, for each of a plurality of electromagnetic signal sources (162), an identifier of that electromagnetic signal source (e.g. MAC address), the position of that electromagnetic signal source (as per the best available estimate), specified as coordinates (which may be 2D or 3D in different embodiments), and a parameter specifying the signal strength of that electromagnetic signal source (which may be a numerical value or another parameter from which signal strength can be deduced, e.g. the type of that electromagnetic signal source). Additional data concerning the electromagnetic signal source may be received from the server database (112) and stored for use in positioning, for example, an estimate of the accuracy of the position of the electromagnetic signal source, a time stamp as to when the electromagnetic signal source was features or most recently detected, and so forth.

The local database also stores, for each region, data (164) about the electromagnetic signal source data for that region. This data may, for example, include data concerning the number or density of electromagnetic signal sources in that region, the age or maturity of the data concerning electromagnetic signal sources, the minimum, maximum and/or average signal strength of electromagnetic signal sources in that region, the minimum, maximum and/or average uncertainty in the estimated position of electromagnetic signal sources in that region. This data can at least in part be computed by the mobile user device when it receives positioning data and updated positioning data from the controller, or it may be received at least in part with positioning data, including updated positioning data, received from the controller.

The observations data (170) is built up during operation of the mobile user device, and records the strength of signals measured by the radio receiver (114). Each observation (172) typically comprises an identifier (e.g. MAC address) of each electromagnetic signal source which was identified at a certain point in time, and a measurement of its corresponding signal strength. This data is stored with reference to the estimated position of the mobile user device when the measurement was taken and the time when the measurement was made. Multiple observations at the same location may be stored as individual observations, or processed to produce data structures derived from multiple measurement events. The observation data typically includes time stamps indicating when the relevant measurements were made, and additional data such as estimates of the accuracy of the signal strength measurements, or the estimated position of the mobile user device at the time that the observation took place.

The local database also stores, for each region, data (174) about the observations data concerning that region. This data may for example, include the amount of observations stored, the number of electromagnetic signal sources which the observations data concerns, the period of time which the stored observations concern, the minimum, maximum and/or average uncertainty in the estimated position of the mobile user device when observations took place, and so forth. This data is computed as the observations are stored, although this is not essential and the data may be computed by a separate procedure.

The data stored in the server database (102) generally corresponds to the locally stored positioning data, but includes additional data required by the controller but not by the mobile user device. The data stored in the server database is typically also grouped by geographical region and in an example embodiment, the following data is stored for each geographical region:
An identifier of, currently estimated position of, and estimated signal strength of individual electromagnetic signal sources in that geographical region
Additional data concerning the individual electromagnetic signal sources, such as when they were first detected, when they were last detected, how often they have been detected, the frequency with which data concerning them has been updated, estimates of the accuracy of the position and signal strength estimates
The time of the last update to the data, the age of the data, the frequency with which the data concerning that geographical region has been updated
Parameters concerning the received signal strength of electromagnetic signal sources in the geographical region (e.g. minimum and maximum signal strength in that region, standard deviation of signal strength in that region)
Data concerning the coverage (e.g. fraction of an area or volume which is within a certain distance of at least two, or at least three electromagnetic signal sources) or maturity of the data in that geographical region.

The maturity of the data is a parameter which starts with a low value when a geographical region is first introduced to the positioning data and new observations lead to significant changes in the accuracy and quality of positioning data and increases as the quality of data concerning the geographical region improves and additional observations have less effect. It may for example be calculated using the following formula:

M=w1(N0/Na)+w2(SUM(Mi)/(N0))+w3(N1/Na)+w4(std(Di)/std0) (5)

Where M is the calculated maturity, w1, w2, w3 are weighting factors, NO is the total number of electromagnetic signal sources in the geographical region for which there is an estimated position, Na is the total number of electromagnetic signal sources detected in the geographical region, Mi is the maturity of the data for electromagnetic signal source i, N1 is the number of electromagnetic signal sources for which the data (estimate of location and/or signal strength) passes a quality check, being a set of thresholds for accuracy, time since first or most recently detected, number of times it has been observed etc., Di is the distance between the centre of the geographical region and the location of electromagnetic signal source i, std0 is the standard deviation of an optimum distribution of electromagnetic signal sources. Mi may be calculated for an individual electromagnetic signal source using the formula:

Mi=w5(N2/Nt)+w6(std(Di)/std0)+w7(C/C0) (6)

Where N2 is the number of observations of electromagnetic signal source i which meet a quality threshold, Nt is the total number of observations of electromagnetic signal source i, Di is the distance between the centre of geographical region and the location of individual observations of the electromagnetic signal source, std0 is the standard deviation of an optimum distribution of observations, C is the area around each electromagnetic signal source within a predetermined distance of at least one observation of the electromagnetic signal source meeting a quality threshold and C0 is the area around each electromagnetic signal source within a predetermined distance of at least one observation if there were an optimum coverage of observations of the electromagnetic signal source.

During operation, the positioning module (116) requests positioning data from the local database (102) required to estimate its current position, for example, data concerning each electromagnetic signal source which it can currently detect (as well as other electromagnetic signal sources nearby). The validation module (188) carries out a validation procedure on the corresponding data stored in the local database (102), thereby regulating the quality of the data available to the positioning module and triggering updates of positioning data, where required.

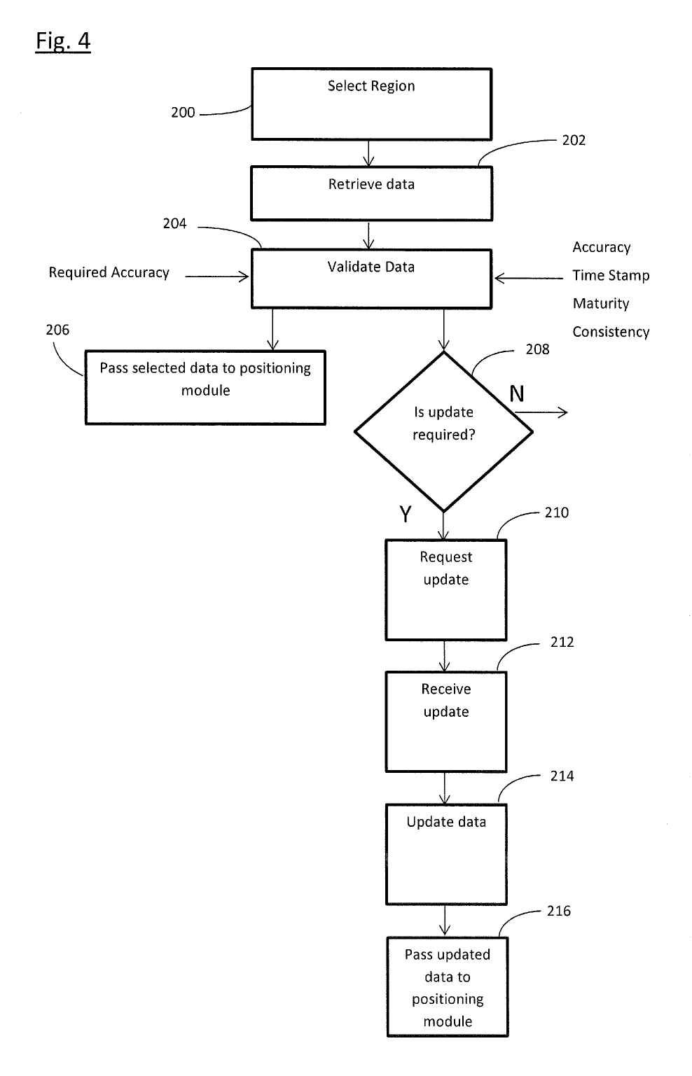

FIG. 4 illustrates the function of the validation module. The validation module selects (200) a region for validation. This selection may be made by the positioning module although the validation module may validate data which is likely to be required shortly, for example on the basis of the current position of the mobile user device, or a region to which the mobile user device is heading, or may go in the future.

The positioning data in the local database concerning the selected region is then validated (202) by the validation module. The validation procedure takes into account issues such the accuracy of the positioning data (e.g. a measure of the accuracy of the estimated position of an electromagnetic signal source), a time stamp regarding when the data was created or last updated, or the time of the most recent measurement (by another mobile user device) of an electromagnetic signal source. Other factors may include the maturity of the data, or its consistency.

The validation procedure aims to select the most accurate positioning data for use by the positioning module, and determine when updates should be requested from the remote server database. For example, if the estimate of the position of some of the electromagnetic signal sources in the region considered by the validation procedure is more accurate than the estimate of the position of other electromagnetic signal sources, the validation procedure may pass only data concerning the former to the positioning module. If there are relatively few electromagnetic signal sources, or a time (e.g. time of creation, time of receipt) of the positioning data concerning some or all of the electromagnetic signal sources is sufficiently old, the validation module may request updated positioning data.

The validation procedure takes into account requirements, such as a required level of accuracy, which varies depending on circumstances. The required level of accuracy may be increased responsive to detection that a user is relying on their current position for accurate (e.g. pedestrian or indoor) navigation, or the mobile user device is executing an application which has a particular requirement for accurate data. The validation procedure may take into account other requirements, such as current charge status of a battery of the mobile user device. When the charge status is relatively low, it may be less likely to request an update of positioning data.

The data validation module then selects or deselects positioning data for use by the positioning module, and passes (206) selected data to the positioning module. Instead of passing the selected data to the positioning module, the positioning module may otherwise indicate which data or should not be used, for example, by passing a list of references to data in the local database or by flagging data in the local database.

The validation procedure also considers whether an update to the locally stored position data concerning the selected region is required (208). Generally, an update is requested if the available positioning data concerning a location does not meet one or more quality criteria. Updates may be requested in advance of being required, for example, before a mobile user device enters a building where detailed positioning information is likely to be required or before a mobile user device switches mode from vehicle to pedestrian navigation.

If this is determined that an update is required, an update is requested from the remote server. The update request is associated with a geographical region. The update request typically comprises a location (e.g. the current location of the mobile user device), or a region (e.g. a reference to a geographical area or volume which includes or is proximate to the mobile user device), although this may not be essential in embodiments in which the controller is aware of the location of the mobile user device.

The update request may comprise data concerning properties of the positioning data stored locally on the mobile user device, particularly properties concerning the quality of that data. For example, as well as a reference to a geographical region, the update request may include one or more of:
a time associated with the locally stored positioning data (e.g. time of creation or last update, time of previous transmission from the controller or time of receipt by the mobile user device) and/or version information
one or more metrics concerning the quality of the locally stored positioning data, e.g. accuracy of or uncertainty in position estimates, or the density of electromagnetic signal sources, or the maturity of the positioning data.

Provided that a communication to the remote server is available, the remote server should receive the request and may respond by transmitting updated positioning data. The remote server may not always respond. For example, if there is no newly updated data concerning the relevant geographical region in the server database, or if an update would be of relatively little assistance, the remote server may determine not to respond by transmitting updated positioning data.

In order to determine whether to send updated positioning data, or which data to send, the controller processes the received data concerning properties of the locally stored positioning data to determine whether it meets one or more quality criteria. The controller may calculate corresponding properties for positioning data stored in the server database and compare the two. For example, the controller may determine whether it has positioning data which is newer than the positioning data stored locally by the mobile user device by more than a first threshold and/or positioning data in which the estimates of the position of electromagnetic signal sources are more accurate in positioning data stored in the server database than locally by the mobile user device by more than a second threshold. The controller may for example calculate a weighted average of a plurality of properties of the locally stored positioning data.

In some embodiments, the controller instead processes stored data concerning properties of the positioning data previously sent to the mobile user device, which may be as simple as the time or version identifier of the last update sent to the mobile user device concerning a geographical region, rather than receiving relevant properties in the update request. The controller may store data concerning when a mobile user device last received updated positioning data, or last received updated positioning data concerning a particular geographical region, to enable it to determine whether and to what extent updated positioning data will assist the mobile user device.

The controller may send updated positioning data in respect of a different geographical region to that referred to the update request, for example a smaller, larger, overlapping or proximate geographical region. This may for example arise if the controller is aware of new (or moved or deleted) electromagnetic signal sources, or significant changes in geographical regions which are near the location of the mobile user device, or to provide some additional data to the mobile user device as a buffer ahead of further movements of the mobile user device.

The request for updated positioning data from the mobile user device to the controller may comprise importance data or requirement data which the controller can interpret to determine what updated positioning data to transmit to the mobile user device, and when it should transmit it. For example, if a mobile user device requires very accurate positioning data immediately, it may transmit importance data requesting that it receives updated data urgently and the controller may priorities transmitting relevant updated positioning data to that mobile user device. If the controller determines that the additional or newer positioning data which it has available will be of relatively little assistance to the mobile user device it may deprioritise and thereby potentially delay the transmission of updated positioning data to the mobile user device.

Provided that updated positioning data is sent by the controller, it should be received (212) by the mobile user device and then used to update (214) the stored positioning data in the local database. The updated data can then be passed to the positioning module (216).

An important feature of the invention is that the data that is requested and received is an update of positioning data, rather than a request to make a complete replacement of the positioning data concerning a region. For example, updated positioning data may comprise data concerning electromagnetic signals sources not previously included in the stored positioning data, or new estimates of the position of electromagnetic signal sources.

This enables the amount of data which is transmitted to be minimised, while still retaining data of sufficient quality to enable the positioning module to carry out positioning to required level of accuracy. Of course, in some circumstances, a request to replace all of the positioning data concerning a geographical region could be made, for example if all of the data concerning a particular region has been deleted, and is now required once more. A mobile user device may request replacement of the positioning data concerning a geographical region more frequently when connected to the internet through a wired connection, or when charging, than when connected to the internet through a cellular telephone network while not being charged.

Accordingly, the mobile user devices and controller both regulate the quality of the positioning data stored on the mobile user device, avoiding excessive data transfer to the mobile user device but prioritising the transfer to the mobile user device of updated positioning data to minimise poor performance of the positioning system.

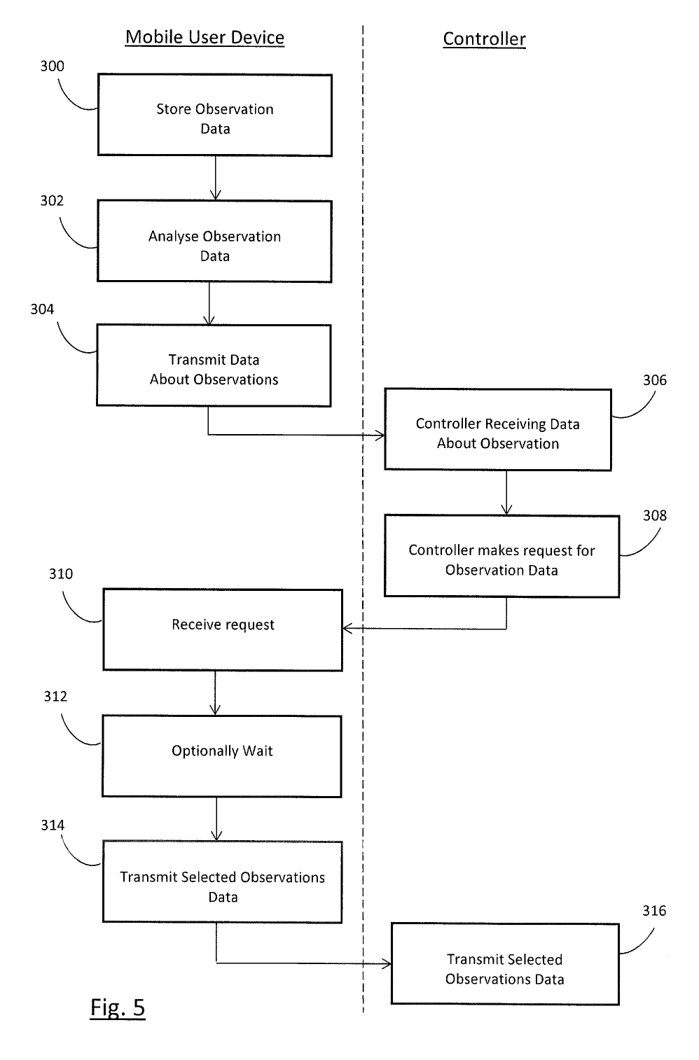

Furthermore, the mobile user devices and controller both regulate the transfer of observations data from the mobile user device to the controller to update the server database. FIG. 5 illustrates the flow of observation data within the system. The positioning module (116) stores (300) observations (172) within the local database (102). Each observation comprises a group of signal strength measurements for some or all of the WAPs detected by the radio receiver (114) and the estimated position at the time at which the observation was made. The observations are stored in a data structure (150A, 150B, 150C) associated with the geographical location where the observations are made. Each observation (172) may include additional relevant data, such as one or more of the time at which the observation was made, the speed at and direction in which the mobile user device was moving when the observation was made, a current estimate of the accuracy of the estimated position of the mobile user device calculated by the positioning module (116), or a quality indicator indicative of the extent to which the measurements made by the radio receiver were compatible with the locally stored positioning data (for example, whether or not signals were detected from WAPs which were expected to be detectable, or whether the measured signal strengths from two or more WAPs are incompatible indicating that there is an error).

The observations module (120) analyses (302) the stored observation data. Typically, it will analyse the stored observation data concerning a specific geographical region. The observation module calculates a number of parameters concerning the stored observation data for the geographical region in question, updated the stored data about the observations (174) and then transmits (304) data about the stored observations to the controller (110). The data which is calculated and transmitted may, for example, include:
An identifier of the geographical region which the data concerns.
The number of stored observations in the respective geographical region.
The time at which the first and latest stored observations in the respective geographical region were made.
A parameter related to the frequency with which observations have been made in respect of this geographical region by the mobile user device.
The minimum, maximum, average (e.g. mean) and variation (e.g. standard deviation) of received signal strength for observations in the respective geographical region.
The minimum, maximum, average (e.g. mean) and variation (e.g. standard deviation) of the estimated error in the position stored with the observations in the respective geographical region.

Accordingly, the controller receives (306) data about the observations data which is locally stored on the mobile user device. The controller then determines whether to request that some or all of the stored observations data is sent to it. If the server database (112) stores positioning data about the geographical region in question which meets criteria concerning how accurate and up to date the data is, it will not usually request that stored observations data is sent to it. However, if the positioning data about the geographical region, or some part of it, does not meet criteria concerning how accurate and up to the date the data is, the controller will be more likely to request the stored observations data. Furthermore, the controller will typically also determine a priority for receiving stored observations data from a particular mobile user device or in relation to a particular geographical region, or part of a geographical region, or particular WAP.

For example, if the mobile user device enters a geographical region where there is very little or no data stored in the server database (112), or where the data that is stored is of low quality (e.g. with high uncertainty in the position of electromagnetic signal sources), the controller will assign a high priority to obtaining data from that mobile user device. If the mobile user device is at a location in respect of which the server database has high quality data, or has recently received observations which have not required significant changes to the stored positioning data, the controller will assign a low priority to obtaining data from the mobile user device.

The controller makes requests (308) for observations data. The request for observations data includes priority data specifying the relative priority of the mobile user device sending observations data to the controller. The relative priority of obtaining data from mobile user devices affects both whether the controller sends a request for stored observation data to a particular mobile user device and the priority data which is included in the request. The volume of requests for observations data can be regulated to control the rate of receipt of data by the controller. The controller can distribute requests for observations data between different mobile user devices, to distribute the load on the individual mobile user devices, and can send further requests for observations to mobile user devices which are close to mobile users devices that do not response to requests for observations data.

The requests for observation data may comprise parameters specifying criteria which, if met, indicate that data concerning an observation should be sent, for example, a maximum estimated position error, minimum received signal strength and/or maximum time since the observation was made required. The requests for observation data may comprise data requesting specific types of observation data or specific locations in respect of which observations data is requested, or identifiers of specific WAPs in respect of which observation data is request, for example.

The controller may transmit requests for additional observations data to be stored to a mobile user device. For example, if the mobile user device is in a location, or may be about to enter a location where the server database (112) has relatively poor data, the mobile user device may be requested to store additional observations data, for example, to store observations data more frequently that would otherwise be the case. Such a request may be transmitted before a mobile user device enters a region, and this feature is relevant where the mobile user device is proximate to a geographical region where electronic communication between the controller and the mobile user device through a communication channel (e.g. a cellular telephone network) will not be possible.

When mobile user devices receive a request for observations data (310), they process the request and determine whether to act on it and whether to do so straight away. Whether they transmit observation data will depend on the priority data included in the request and additional factors, such as how much electrical power would currently be required to transmit observation data. This will depend on factors such as the availability of relatively low power communications channels (e.g. the availability of WiFi) and the current power requirements of available communications channels, for example the current power requirement of transmitting data to a mast of a cellular telephone network or to a network base station (e.g. a WAP through which it is in communication with the internet). As well as determining whether to transmit observation data, the mobile user device will determine whether to wait (312) before transmitting the observation data, or not. This will again depend on the priority data included in the request, and additional factors, such as the current power requirement of available communications channels, the state of charge of a battery of the mobile user device and so forth. For example, the mobile user device might wait until the next time the mobile user device is connected to the internet through a wired connection or through a relatively low power wireless connection, or the next time that it is being charged, if the priority data indicates a relatively low priority, but may transmit observation data urgently if the priority data indicates a relatively high priority. Observation data may be combined with other data which is to be transmitted to the controller to minimise power consumption.

When it is determined that observation data should be transmitted, observation data is selected, taking into account the above data specifying criteria which should be met for observation data to be transmitted, and the observation data is then transmitted (314) to the controller which receives the selected observation data (316) and uses it to update the positioning database (112), for example by adding data concerning the location and strength of signals for newly discovered wireless access points, improving estimates of the position and/or strength of signals for existing wireless access point, or deleting data concerning wireless access points which are found no longer to be present.

The observation data can be used to improve the estimates of position of electromagnetic signal sources using the current estimated positions of the electromagnetic signal sources, estimated positions where observations took place and the measured signal strengths by amending the estimated positions and/or signal strengths of electromagnetic signal sources so that they gradually converge towards a best fit estimate. For example, observations data concerning the estimated position of mobile user devices when an electromagnetic signal source was observed, and the measured signal strength from the respective electromagnetic signal source, may be processed to improve the estimated position of the electromagnetic signal source. This procedure may be enhanced by suitable weighting of each observation depending on the accuracy of the estimate of the position of a mobile user device when the respective observation took place, and to balance the weight of measurements of the position of electromagnetic signal sources from different directions, even though observations may not be from locations which are evenly distributed around electromagnetic signal sources. This can lead to a gradual improvement in the quality of the data because subsequent estimates of mobile user device position will be improved, leading to a convergence of the data.

When data concerning an electromagnetic signal source is updated, the controller typically stores data concerning when that update took place, to enable subsequent determination as to whether a mobile user device already has the most up to date information concerning an electromagnetic signal source or whether newer data could be transmitted in response to a request for updated positioning data.

Accordingly, the decision as to what observation data should be transmitted is distributed between both the individual mobile user devices and the controller. Hence the system as a whole can regulate the relaying of observation data from mobile user devices to the controller, minimising bandwidth and power consumption for a given accuracy of positioning data.

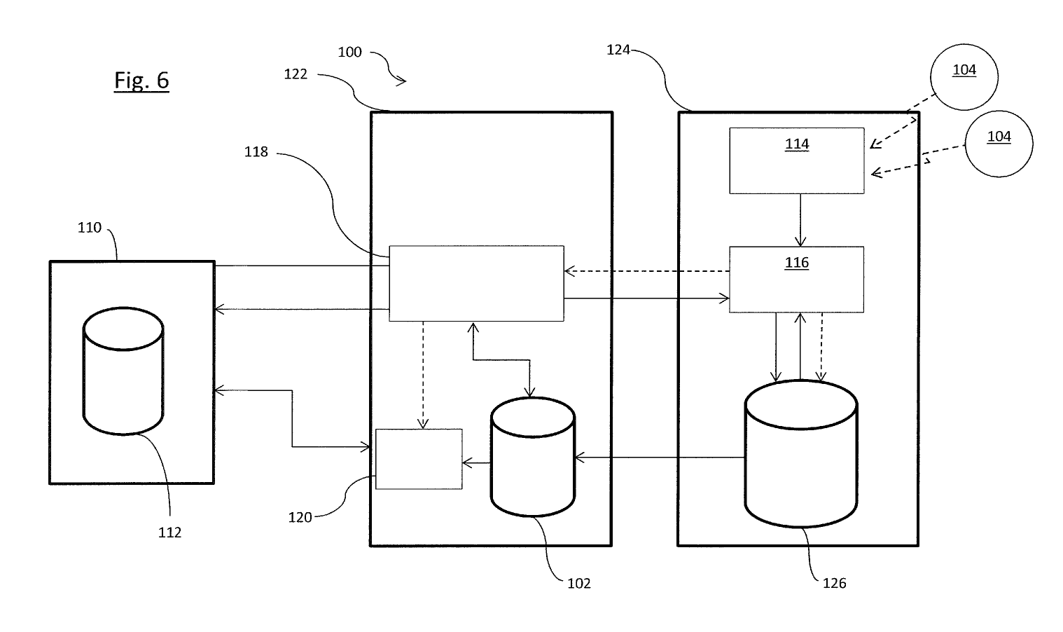

In alternative embodiments, the functionality of the mobile user device may be distributed between one or more components of the mobile user device which are in wireless communication with each other, and typically both carried around at once by an individual user. With a reference to FIG. 6, the mobile user device comprises a mobile telephone (122), and a separate wearable component, such as a watch or glasses (124), except that in this example embodiment the validation module (118), local database (102) and observations upload module (120), are located in the body of the mobile telephone, and the radio antenna (114), and positioning module (116), are located in the wearable accessory, along with a stored buffer (126), which stores observations to transmit using a wireless connection to the mobile telephone, for inclusion in the local database (102), and which receives validated positioning data, and transmits requests for positioning data to the data validation module (118) over a wireless link.

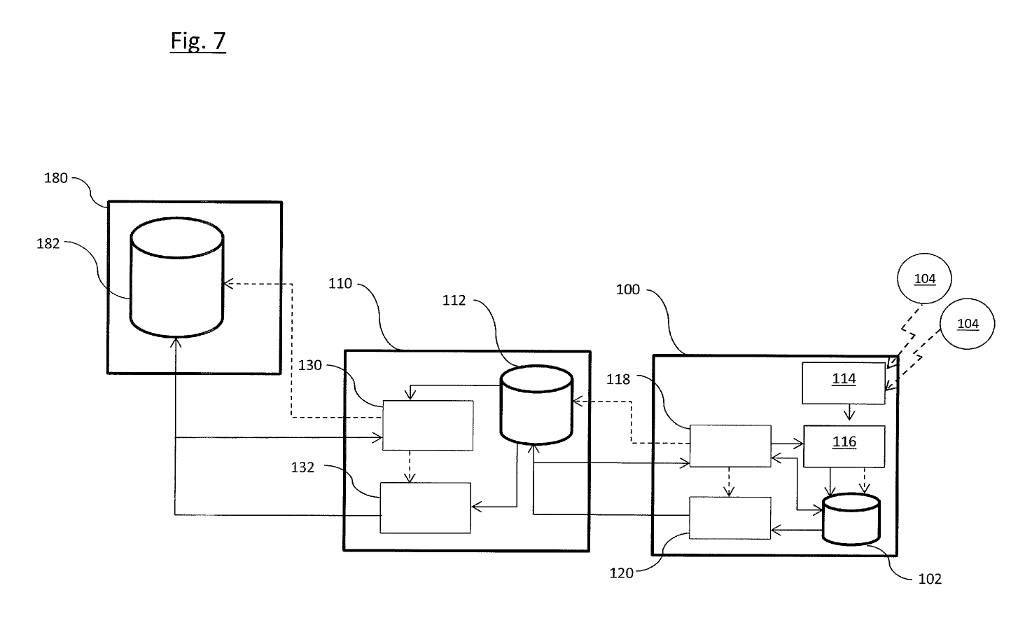

In further embodiments, illustrated in FIG. 7, the controller is part of a network of controllers. In the embodiment of FIG. 7, the controller (110) maintains a server database (112) relating to a particular geographical location, such as a building, part of a building (e.g. floor of a building), town, city or country, and communicates with the mobile user devices in that location. However, the controller is also in communication with a further database (190) which may be a centralised global database of positioning data, or a superior database in a hierarchy of databases. In this embodiment, the controller comprises a data validation module (130), which validates the data in server database (112), and requests updates from a central database (182), where the data in the server database (112) does not meet a quality standard.

As with the validation module of the mobile device, the validation module of the controller takes into account factors such as the age, accuracy, maturity and quality of the positioning data stored in the server database concerning a particular geographical region. The controller receives uploaded observation data from the mobile user device, and itself includes an observations uploads module (132), which the further controller (180) with data concerning the observations data stored in the server database (112). In this case, the controller (110) and the server database (112), function as a small cell, storing data relevant to a particular geographical locale, such as a building (e.g. an airport terminal, or a railway station, or an office building), or a town, enabling much of the data processing and upkeep of the positioning database to be distributed between the controller and the mobile user devices in the relevant location, but also enabling the central server to store, back up, and process observations data and positioning data, to improve the overall function of the system.

The controllers of the network typically comprise control modules programmed to determine which controller an individual mobile user device communicates with to transmit observations and to request position updates.

One skilled in the art will appreciate that there are other ways in which a database of positioning data may be configured. For example, in alternative embodiments, the server database of positioning data additionally or instead comprises fingerprint data, being, for each of many positions (e.g. a grid of positions), data specifying an identifier (e.g. MAC address) of electromagnetic signals sources which may be detected at that location and their signal strength.

Thus, the positioning data stored locally on the mobile user device may comprise fingerprint data (162), for each of many locations within the respective region (typically specified as coordinates). Fingerprint data typically comprises a list of identifiers (e.g. MAC addresses) of WAPs which may be detected at that location, along with the expected strength of signals from the respective WAPs at the respective locations. The fingerprint data may comprise additional information, for example an estimate of the accuracy of some or all of the data at that location, or the time at which the signal strength data for that location was last measured (by another mobile user device), or processed. The fingerprint data (160) for an individual region will typically comprise further data, including a time stamp as to when the fingerprint data was generated, and when it was received by the mobile user device.

Still further alternatives include storing parameters of functions which describe how the strength of signals from specific electromagnetic signal sources varies spatially at a particular geographical location.

1. A method of maintaining stored positioning data on a mobile user device, comprising:
the mobile user device receiving and storing positioning data, the positioning data concerning a plurality of electromagnetic signals sources, signals from the said electromagnetic signal sources, and geographical locations of the said electromagnetic signal sources or signals from the said electromagnetic signal sources;
subsequently carrying out a data validation procedure to determine whether to update the stored positioning data relating to a geographical region and, if so, requesting updated positioning data relevant to the said geographical region, receiving updated positioning data relevant to the said geographical region and updating the stored positioning data with the updated positioning data.

2. A method according to claim 1, wherein the data validation procedure analyses the stored positioning data relating to a geographical region to determine whether to update the stored positioning data relating to that geographical region, wherein the positioning data is grouped by or stored with reference to a plurality of discrete geographical regions, which may be of the same or different sizes and shapes.

3. A method according to claim 1, wherein the received updated positioning data comprises updates to the stored positioning data and the step of updating the positioning data does not replace all of the stored positioning data relating to the said geographical region.

4. A method according to claim 1, wherein the data validation procedure takes into account a time associated with the stored positioning data.

5. A method according to claim 1, wherein the data validation procedure takes into account a parameter associated with the maturity, level of confidence, consistency, or expected rate of change of the stored positioning data relating to the geographical region, of part thereof.

6. A method according to claim 1, wherein the mobile user device estimates its position using a selected subset of the stored positioning data and the data validation procedure comprises determining which positioning data relating to a geographical region is to be used in the estimation of the position of the mobile user device.

7. A method according to claim 6, wherein the data validation procedure determines in some circumstances that some or all of the stored positioning data relating to the geographical region should not be selected for use in the estimation of the position of the mobile user device and requesting updated positioning data relevant to the geographical region.

8. A method according to claim 1, wherein the request for updated positioning data is transmitted to a controller which comprises a server database storing positioning data, the controller receives the request for updated positioning data and transmits the updated positioning data, derived from data in the server database of stored positioning data, to the mobile user device.

9. A method according to claim 1, wherein the mobile user device transmits property data concerning one or more properties of stored positioning data relevant to the geographical region, to the controller.

10. A method according to claim 9, wherein the controller determines from one or more said properties whether and/or when to send the updated positioning data to the mobile user device, and/or which positioning data to include in the updated positioning data sent to the mobile user device.

11. A mobile user device comprising:
a positioning module programmed to estimate the position of the mobile user device from measurements of signals associated with one or more electromagnetic signal sources, with reference to stored positioning data;
a data validation module programmed to determine whether the stored positioning data relating to a geographical region should be updated and, if so, to request updated positioning data relevant to the said geographical region;
an updating module programmed to receive (typically requested) updated positioning data and to update the stored positioning data with the updated positioning data.

12. A mobile user device according to claim 11, wherein the data validation module is programmed to determine a subset of the stored positioning data which is used by the positioning module and to in some circumstances cause the position module to use none or only some of the stored positioning data concerning a geographical region and to request updated positioning data concerning the said geographical region.

13. A mobile user device according to claim 11, wherein the mobile user device comprises a plurality of separate or separable components which are in wired or wireless communication with each other.

14. A system comprising a controller, a server database in electronic communication with the controller, the server database storing positioning data, and a plurality of mobile user devices according to claim 11, which are at at least some times in electronic communication with the controller, the controller programmed to receive the requests for updated positioning data from the plurality of mobile user devices and to cause said updated positioning data from the server database to be transmitted to the said mobile user devices responsive to the said requests.

15. A system according to claim 14, wherein the controller is programmed to cause said updated positioning data from the server database to be transmitted to the said mobile user devices selectively in response to the said requests.

16. A system according to claim 14, comprising a plurality of said controllers and server databases, a controller and respective server database being associated with each of a plurality of different geographical zones, the server database associated with each geographical zones storing positioning data concerning the respective geographical zone, the mobile user devices transmitting said request for updated positioning data to the controller associated with the geographical zone where the mobile user device is located and receiving updated positioning data from the server database associated with the geographical zone where the mobile user device is located.

17. A method of updating a server database of positioning data using signal measurements made by mobile user devices, the server database comprising data concerning a plurality of electromagnetic signal sources, the method comprising:
a mobile user device measuring signal data from a plurality of electromagnetic signal sources and locally storing observation data derived from the measured signal data,
the mobile user device transmitting data about the locally stored observation data to a controller,
the controller selectively transmitting requests to the mobile user device to transmit at least some of the locally stored observation data;
the mobile user device receiving said requests and subsequently transmitting some or all of the requested locally stored observation data;
updating the server database using the transmitted observation data.

18. A method according to claim 17, wherein the mobile user device delays sending requested locally stored observation data to the controller until at least one data transmission criterion is met, even whilst it is possible for the mobile user device to send the data to the controller through a communications channel.

19. A method according to claim 18, wherein the at least one data transmission criterion is selected to reduce the power consumption of the mobile user device associated with the transmission of observation data to the controller.

20. A method according to claim 18, wherein the at least one data transmission criterion may relate to whether the mobile user device is able to send the data to the controller through a relatively low power communication channel.

21. A method according to claim 17, wherein the requests to the user device include priority data and the mobile user device takes into account the priority data when determining whether and/or when to send locally stored observation data to the controller.

22. A method according to claim 17, wherein the data about the locally stored observation data comprise data concerning the accuracy of the observation data or data concerning the time at which the observation data was obtained or data indicating detection of an electromagnetic signal source of which the mobile user device was not aware or data identifying detected electromagnetic signal sources or data concerning whether and/or to what extent the observation data is inconsistent with stored positioning data.

23. A method according to claim 17, wherein the controller transmits further data about the observation data received from the mobile user device, or concerning positioning data stored in the server database, to a further controller, the further controller requests selected observation data, or positioning data from the server database, from the controller responsive to the further data about the observation data, and the controller transmits the selected observation data, or positioning data from the server database, to the further controller.

24. A method according to claim 23, wherein the controller transmits a request to the mobile user device to transmit locally stored observation data relating to a specific geographical region responsive to a request from the further controller for data concerning the specific geographical region.

25. A mobile user device comprising stored positioning data, a radio receiver which measures signals from electromagnetic signal sources, a positioning module which estimates the position of the mobile user device from the signals measured by the radio receiver, a data store which stores observations data concerning signals from electromagnetic signal sources measured by the radio receiver, an observations upload module which is programmed to transmit data concerning the (locally stored) observations data and which is programmed to transmit selected stored observations data responsive to a received instruction.

26. A system comprising a controller, a server database of positioning data in electronic communication with the controller, and a plurality of mobile user devices, the server database comprising data concerning a plurality of electromagnetic signal sources,
a mobile user devices programmed to measure signal data from a plurality of electromagnetic signal sources and comprising local data storage locally storing observation data derived from the measured signal data,
the mobile user devices programmed to transmit data about the locally stored observation data about the locally stored observation data to the controller,
the controller programmed to transmit requests to the mobile user devices to transmit at least some of the locally stored observation data;
the mobile user devices programmed to receive said requests and subsequently transmit some or all of the requested locally stored observation data;
the controller programmed to update the server database using the observation data received from the mobile user devices.

27. A system according to claim 26, comprising a plurality of said controllers and respective server databases, and further comprising a master controller and a master database in electronic communication with the master controller,
the controllers programmed to transmit to the master controller further data about the observation data received by the respective controllers, or positioning data within the respective server database,
the master controller programmed to process the received further data about the observation data and to transmit requests to the respective controllers for selected observation data or positioning data,
the respective controller programmed to receive said requests and to transmit the requested observation data or positioning data to the master controller responsive thereto,
the master controller programmed to update the master database using the observation data or positioning data thereby received.

28. A system according to claim 27, comprising a controller selection module programmed to select a controller for an individual mobile user device to communicate with in dependence on the measured position of the mobile user device
